(19) United States
(12) Patent Application Publication
(10) Pub. No.: US 2004/0082732 A1
(43) Pub. Date: Apr. 29, 2004

(54) Crosslinkable oligoimides

(76) Inventors: Eric Toussaere, Lannion (FR); Bernard Boutevin, Montpellier (FR); Laurence Bes, Montpellier (FR); Alain Rousseau, Montpellier (FR); Regis Mercier, Irigny (FR); Bernard Sillion, Lyon (FR)

Correspondence Address: Blakely Sokoloff, Taylor & Zafman, 7th Floor, 12400 Wilshire Boulevard, Los Angeles, CA, 90025, US

(21) Appl. No.: 10/470,064

(22) PCT Filed: Jan. 21, 2002
(86) PCT No.: PCT/FR02/00229

(30) Foreign Application Priority Data
Jan. 22, 2001 (FR) 01/00801

(51) Int. Cl. B05D 5/06; C08G 69/48

(52) U.S. Cl. 525/421; 427/162; 528/310

(57) ABSTRACT

The invention concerns a method for obtaining an electrooptic material characterised in that it consists in depositing on a substrate a solution of oligoimides whereon are grafted colouring agents capable of being oriented and in performing a treatment designed to cross-link the oligoimides and to provide orientation to the colouring agents.

The present invention relates to the manufacture of electrooptic materials and in particular to the manufacture of electrooptic components. These components may be involved in optical signal processing applications, in particular the modulation, the switching and the coding of one or more optical carriers.

In particular, this invention applies to components using polymers exhibiting optical properties of second-order non-linearity.

Electrooptic polymers have high potential in the field of telecommunications. These are materials which can make possible the manufacture of inexpensive components and which can be implemented in fiber-to-the-home (FTTH) optical fiber distribution networks (Y. Shi et al., “Fabrication and characterization of High-Speed Polyurethane-Disperse Red 19 Integrated Electrooptic Modulators for Analog System Applications”, IEEE J. of Selected Topics in Quantum Electronics, Vol. 2(2), 1996, 289-298) or in radio distribution networks (S. A. Hamilton, D. R. Yankelevich, A. Knoesen, R. T. Weverka, R. A. Hill, G. C. Bjorklund, “Polymer in-line fiber modulators for broadband radio-frequency optical links”, J. Opt. Soc. Am., B, 15(2) 1998, 740-750). Furthermore, by virtue of their rapid response time of electronic origin (D. Chen et al., “Demonstration of 110 GHz electro-optic polymer modulators”, App. Phys. Lett., 70(25), 1997) and of the low dispersion of their dielectric constant, they can be used in more complex circuits for microwave signal processing (T. Nagatsuma, M. Yaita, M. Shinagawa, “External electro-optic sampling using poled polymers”, Jpn. Appl. Phys., 31, 1992, 1373-1375) or optical delay lines (R. L. Q. Li, H. Tand, G. Cao, T. T. Chen, “Optically heterodyned 25 GHz true-time delay lines on thick LD-3 polymer-based planar waveguides”, Appl. Opt., 36(18), 1997, 4269). They are easy to form and the forming process employs technologies which are proven in the field of semiconductors (U.S. Pat. No. 5,291,574, Levenson Regine; Liang Julienne, Carenco Alain, Zyss Joseph, “Method for manufacturing strip optical waveguides” (1994)). They thus make it possible to prepare, in a simple way, waveguides and more generally optical circuits on various substrates. The forming thereof under other formats also allows them to be used in the storage of information by linear holography (Z. Sekkat, J. Wood, W. Knoll, W. Volken, R. Miller, A. Knoesen, “Light induced orientation in azo-polyimide polymers 325° C. below the glass transition temperature”, J. Opt. Soc. Am. B, 14(4) (1997), 829-833) or nonlinear holography (J. Si, T. Mitsuyu, P. Ye, Y. Shen, K. Hirao, “Optical poling and its application in optical storage of a polyimide film with high glass transition temperature”, Appl. Phys. Lett., 72(7), 1998, 762-764).

In order to obtain quadratic nonlinear optical properties, these polymers have to be oriented in a non-centrosymmetrical fashion. For example, in order to obtain orientation under an electric field at high temperature (vicinity of the glass transition temperature), the polymer to be oriented is placed between electrodes. A considerable electric field (of the order of 100 V/μm or more) is applied between these electrodes. This field orientates the molecules by dipole interaction; this orientation is subsequently rendered permanent by cooling the polymer while maintaining the applied field. To test the electrooptic effects of the substrate thus obtained, a modulating electric field is applied between the electrodes and makes it possible to modulate the refractive index of the polymer via the Pockels effect. This is reflected by a phase shift in the optical wave propagating in the oriented polymer; this phase shift can be used to process the optical signal (modulation or switching).

The stability of the components is important for the practical applications. A question which has formed the subject of numerous studies is the orientational stability of. “chromophores” (also known as “dyes”) in polymer films. This is because this induced molecular order, the source of the nonlinearity, can relax over time.

These studies refer to the preparation of materials in which the orientation of the dyes can be permanently frozen. From the first doped polymers, progress was thus rapidly achieved toward grafted polymers in which the active molecules are connected covalently to the matrix. This bonding limits the relaxation of the orientation but it can be strengthened even more by a subsequent chemical reaction which attaches the dye via other covalent bonds (J. Liang, R. Levenson, C. Rossier, E. Toussaere, J. Zyss, A. Rousseau, B. Boutevin, F. Foll, D. Bosc, “Thermally stable crosslinked polymers for electro-optic applications”, J. Phys. III France, 4, (1994, 2441-2450)). This approach has been complemented by the sol-gel technique, use of which has made possible the synthesis of materials which can be crosslinked at low temperature (U.S. Pat. No. 5,449,733, Zyss Joseph, Ledoux Isabelle, Pucetti Germain, Griesmar Pascal, Sanchez Clément, Livage Jacques, “Inorganic sol-gel material which has a susceptibility of the second order”, 1995).

Furthermore, another solution consists in looking for polymer matrices with a high glass transition temperature and in modifying them in order to introduce therein a significant amount of dyes (T. Verbiest, D. M. Burland, M. C. Jurich, V. Y. Lee, R. D. Miller, W. Volksen, “Exceptionally Thermally Stable Polyimides for Second Order Nonlinear Optical Applications”, Science, Vol. 268, 1995, 1604-1606). Lastly, a final approach consists in preparing interpenetrating networks combining polymers, such as polyimides, and a sol-gel matrix to which dyes are grafted (R. J. Jen, Y. M. Chen, A. K. Jain, J. Kumar, S. K. Tripathy, “Stable Second-Order Nonlinear Optical Polyimide/Inorganic Composite”, Chem. Mater., 1992, 4, 1141-1144).

These various approaches combine either polymers or sol-gel matrices. The first class of materials (noncrosslinked) can present problems of solubility (a good solvent has to be found for the deposition of the polymers) and of insolubility (to make possible successive depositions of multilayers necessary for the preparation of waveguides). Sol-gel materials are themselves relatively difficult to control as the repeatability of their processing, and therefore the stability of the orientation of the dyes, depends on the reproducibility of the temperature and hygrometry conditions. Furthermore, the stability of the orientation of molecules in a sol-gel matrix depends on the density of the crosslinking. High stiffness of the network thus implies a lower concentration of dyes, which limits the effectiveness of the final component.

One aim of the invention is to overcome these disadvantages by providing a process for the production of a polymer matrix which can be dissolved by conventional solvents and which exhibits better stiffness.

To this end, the invention provides a process for the preparation of an electrooptic material, characterized in that a solution of oligoimides, to which orientable dyes are grafted, is deposited on a substrate, in that the oligoimides are crosslinked by annealing, and in that the dyes are oriented.

The term “polymers” means a molecule in which a unit, the monomer, is repeated a large number of times (up to several thousand times). The term “Oligomer” means a molecule in which the unit is repeated less than 20 times.

The use of oligoimides instead of the polyimides conventionally used makes possible better solubility of the matrix obtained, which facilitates the forming thereof. This increased solubility is due both to the presence of end groups and to the fact that the chains are shorter than those of the polyimides. It is possible, by virtue of this novel structure, to easily obtain films with a thickness of the order of a micrometer, which renders them compatible for the manufacture of waveguides. In addition, this solubility makes it possible to dissolve them in conventional solvents of low toxicity.

In particular, the invention provides for the use of fluorinated oligoimides. The use of fluorinated oligomers, introduced during the polymerization, makes it possible to reduce the sensitivity to moisture of the material obtained.

The oligoimide solution used in the process is obtained by the following stages:

the synthesis of oligoimides terminated by reactive double bonds,

the addition of the orientable dyes to the OH functional side groups of the oligoimides,

the grafting of crosslinking groups to the double bonds at the chain end.

The use of crosslinking groups of alkoxysilane, nadic or allylic type, for example, makes possible crosslinking and densification of the films after deposition. This crosslinking renders them insoluble while conferring optical transparency thereon.

In addition to alkoxysilane groups, it is also possible to envisage the preparation of oligoimides terminated by maleimide, acetylene, benzocyclobutene or cyanate groups which crosslink by thermal self-condensation.

The oligoimides can be self-crosslinkable (via alkoxysilane, nadic or allylic functional groups) or crosslinkable via an additional crosslinking agent (for example, 1,1,1-tris(4-hydroxyphenyl)ethane or oxalic acid). The crosslinkable oligoimides can therefore be provided in the form of a single-component material, that is to say exhibiting the two crosslinkable functional groups on the oligoimide chain, or of a two-component material, that is to say result from a reaction between two components.

In the case of a two-component material, the crosslinking can be carried out by reaction of alkoxysilane with hydroxylated crosslinking agents but it can be envisaged in the form of a reaction of a compound carrying at least three functional groups capable of reacting with the double bonds situated at the chain end.

For example, to obtain oligoimides possessing nonlinear optical properties terminated by nadic double bonds, the crosslinking can be envisaged by radical addition to the nadic double bonds of a multifunctional compound of the tri- or tetrathiol type, such as pentaerythritol tetrakis(3-mercaptopropionate).

To obtain oligoimides terminated by allylic double bonds, the crosslinking can be carried out by hydrosilylation reaction with tetra- or pentafunctional compounds, such as tetramethylcyclotetrasiloxane.

The crosslinking reactions can be basic: simple annealing is sufficient. This annealing also makes it possible to evaporate the residual solvents. The crosslinking renders the material insoluble, which allows it to be easily used in multilayer depositions since the lower layers are not detrimentally affected during the deposition of additional layers. Furthermore, this insolubility does not prevent subsequent orientation of the dyes, which allows it to be used effectively as technological stage without harming the nonlinear effectiveness of the material, if the latter is oriented after crosslinking.

In addition to the crosslinking of the oligoimides, it is possible to crosslink reaction sites placed on the dyes, which allows the stability of the material obtained to be further strengthened. This type of crosslinking has already been used in the past, for example in the case of methacrylic polymers.

This family of materials employs reactions for the synthesis of soluble polyimides which are well controlled and which are carried out with good yields. Their synthesis and their processing can take place at relatively low temperatures (less than 300° C.). By virtue of their high glass transition temperature, due to the imide groups in the main chain, the matrices obtained remain stable at temperatures greater than the temperatures envisaged for their uses (less than 85° C.).

These polyimides can readily participate in blending operations as their chemical structures are similar. It is thus possible to finely adjust specific properties, such as the refractive index, the resistivity or the dielectric constant of the material, during the use and the forming, by blends of different synthetic batches. It is thus possible to obtain products suited to a precise use. For example, the refractive indices of the various constituent layers of a waveguide can be adjusted in order to optimize their thicknesses. It is also possible to adjust the various resistivities in a multilayer in order to optimize the electric field transfer on the active layer. Finally, the dielectric constant of the material can be adapted in order to adapt phase velocities in electrooptic modulation at a very high frequency. The ease with which these mixings can be carried out also makes it possible to envisage simply preparing novel multifunctional materials into which a new functional group can be simply introduced or in which a new functional group can be simply reinforced. For example, it is possible to combine, in the same material, electrooptic properties with photoluminescence properties, electroluminescence properties or photovoltaic effects. It is also possible to strengthen its hydrophobic nature.

The nonlinear optical properties of the materials composed of a matrix of oligoimides are comparable to or better than that obtained using the corresponding model polyimides. As regards the quadratic nonlinear optical components, the dyes used have to be hyperpolarizable in order to provide for their orientation, that is to say that they should preferably exhibit an optical quadratic hyperpolarizability tensor with at least one coefficient of greater than 10⁻³⁰ e.s.u. The orientational stability of the organic dyes can be characterized by the measurement of the nonlinear optical coefficient as a function of the temperature by measuring, during the heating thereof, the variation in the second harmonic intensity generated by a film of the compound.

Other characteristics and advantages will further emerge from the description which follows, which is purely illustrative and nonlimiting and should be read with regard to the appended drawings, in which:

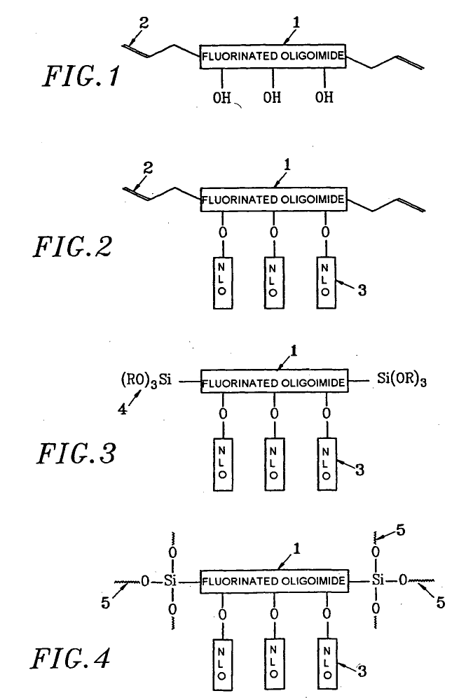

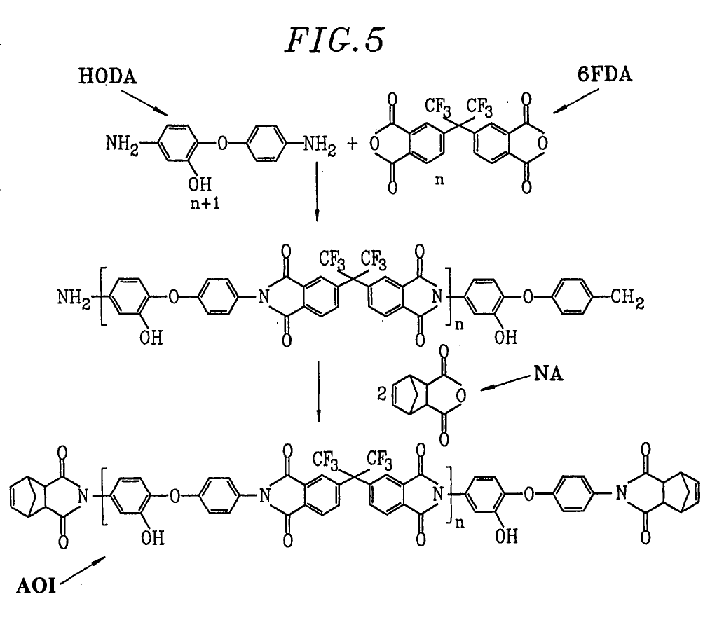

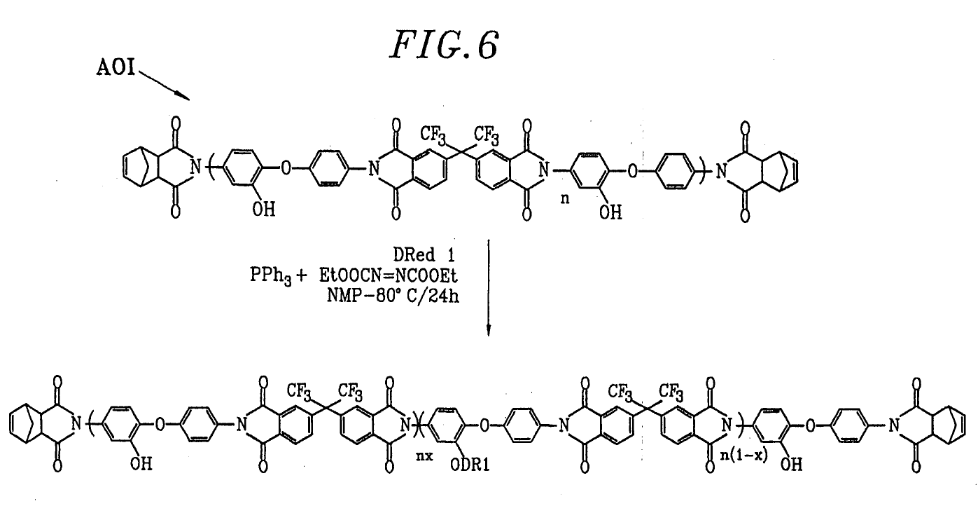

FIGS. 1 to 4 represent the successive stages which make possible the preparation of an electrooptic material according to the invention.

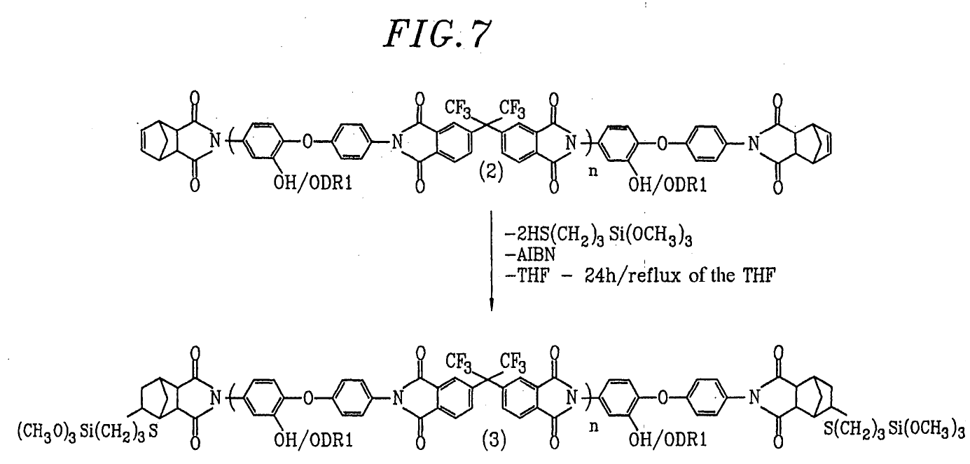

FIGS. 5 and 7 are reaction diagrams which illustrate the various stages of the process for the manufacture of an electrooptic material, in which the oligoimide is oligohydroxyimide, the grafted dye is Disperse Red One and the crosslinking agent is a mercaptosilane derivative.

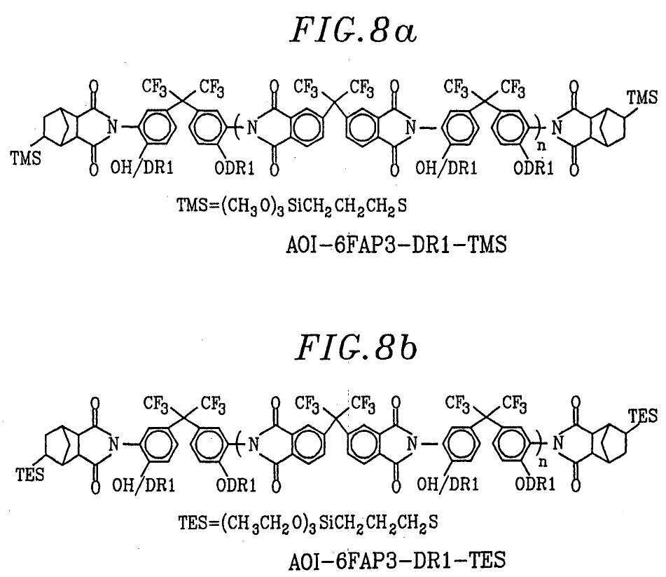

FIGS. 8a and 8b represent two chemical structures of crosslinkable oligoimides on which stability measurements have been carried out,

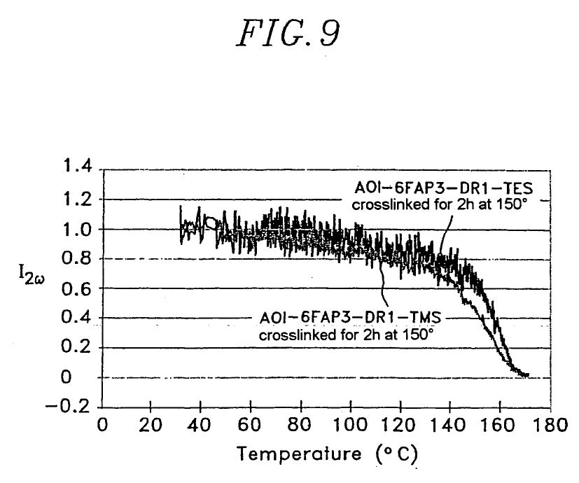

FIG. 9 represents the relaxation curves of the signals obtained for the two types of electrooptic material of FIGS. 8a and 8b,

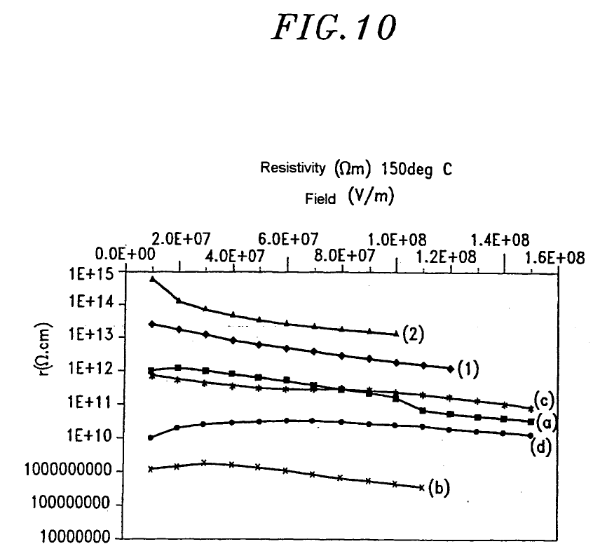

FIG. 10 collates the curves for the measurement of the resistivity of various electrooptic materials as a function of the electric field applied.

The various stages in the manufacture of an electrooptic material can be visualized in FIGS. 1 to 4. The first stage, represented in FIG. 1, consists in synthesizing an oligohydroxyimide 1 exhibiting reactive double bonds 2 at its ends and OH functional side groups. In a second stage, represented in FIG. 2, chromophores 3 are added to the OH functional side group via the Mitsunobu reaction. In a third stage, crosslinking groups 4 of trialkoxysilane type are added to the double bonds 2 at the chain end. Finally, in a fourth stage, the oligohydroxyimides are crosslinked thermally, which results in the formation of bonds 5 between the crosslinking groups 4.

The following example is a detailed example of a process for the manufacture of an electrooptic material in accordance with the invention. In this example, use is made of the starting materials prepared or identified as follows.

The oligohydroxyimides are synthesized with 4,4′-(hexafluoroisopropylidene)diphthalic anhydride (6FDA).

Three families of oligoimides which differ in the hydroxydiamine used were prepared. The three types of hydroxydiamine are:

4-(4-amino-2-hydroxy)phenoxyaniline (HODA),

2,2-bis(3-amino-4-hydroxyphenyl)hexafluoropropane (6FAP),

3,3′-dihydroxy-4,4′-diaminobiphenyl (DHB).

4,4′-(Hexafluoroisopropylidene)diphthalic anhydride (6FDA) (sublimed at 200° C. under 0.1 mmHg), nadic anhydride (recrystallized from acetic acid) and the chromophore Dispersed Red One (DR1), purified by chromatography on a silica column (eluent: chloroform), are supplied by Aldrich (France).

The synthesis of the diamine 4-phenoxy-(4-amino-2-hydroxy)aniline (HODA) and of its isomer, 4-phenoxy-(3-amino-2-hydroxy)aniline, is described in the literature. The diamine 2,2-bis(3-amino-4-hydroxyphenyl)hexafluoropropane (6FAP) (Interchim) is purified by sublimation at 170° C. under 5 Pa and the diamine 3,3′-dihydroxy-4,4′-diaminobiphenyl (DHB) (Interchim) is used as is.

Example of the process for the preparation of an electrooptic material:

Stage 1: Synthesis of the Oligohydroxyimides (AOI) Terminated by Nadic and Allylic Double Bonds.

The reaction diagram for the synthesis of oligoimide based on HODA and on 6FDA terminated by nadic double bonds is given in FIG. 5.

A general procedure is described hereinbelow which is applicable to the synthesis of active oligomers (AOI). The amounts of the various monomers are collated in table 1.

The diamine (HODA, 6-FAP or DHB) and the dianhydride 6FDA are dissolved in a solution of 1-methyl-2-pyrrolidinone (NMP) with a concentration by mass of 20% in a 100 ml three-necked flask equipped with a mechanical stirrer and with a nitrogen inlet. The solution is stirred at ambient temperature for 18 hours under a stream of nitrogen, then it is gradually heated to 160° C. and is left at this temperature for 3 hours. The solution is cooled to ambient temperature and the terminating agent (either allylamine AA or nadic anhydride AN) is added. The solution is subjected to the same temperature cycle as above, then it is cooled and precipitated from one liter of a 1:1 mixture of methanol/water. The white product is filtered off, then washed several times with methanol and dried. The physicochemical characteristics of each oligomer are given in table 2.

Stage 2: Addition of the Chromophore DR1 to the Oligohydroxyimides (AOI).

The reaction diagram for the grafting of DR1 to the oligoimides based on HODA and on 6FDA terminated by nadic double bonds is given in FIG. 6.

A general procedure is described below which is applicable to the synthesis of AOI-DR1 oligomers. The amounts of the various reactants are collated in table 3.

One equivalent of oligohydroxyimide [lacuna] of DR1 and 1.5 equivalents of triphenylphosphine (PPh₃) are dissolved in NMP in a three-necked flask equipped with a nitrogen inlet and with a dropping funnel. The solution is stirred until all the compounds have dissolved. The solution is heated to 80° C. and 2.5 equivalents of diethyl azodicarboxylate (DEAD) are added to the solution. The reaction mixture is stirred at 80° C. for 24 hours. Monitoring by thin layer chromatography (TLC) makes it possible to report the progress of the reaction. The solution is subsequently precipitated from methanol. The red precipitate is filtered off and washed with methanol. The polymer is purified by extraction on a Soxhlet device with methanol until the residual chromophore has been removed (monitoring by TLC) and is finally dried under vacuum at 100° C. Quantitative determination by UV/visible spectrometry makes it possible to determine the levels of grafting. The characteristics of the UV/visible quantitative determination are given in table 4.

Stage 3: Synthesis of the α,ω-alkoxysilane Oligoimides Grafted with DR1.

The reaction diagram for the synthesis of α,ω-trialkoxysilane oligoimide based on HODA and on 6FDA is given in FIG. 7.

An example of synthesis and of characterization is described below for the radical addition of a mercaptosilane derivative to nadic double bonds. It is applicable to any other α,ω-trialkoxysilane oligoimide.

One equivalent of oligoimide terminated by nadic double bonds, two equivalents plus 10% excess (2.1) of (3-mercaptopropyl)trialkoxysilane and 10 mol % of azobisisobutyronitrile (AIBN) are dissolved in tetrahydrofuran (THF) in a 100 ml two-necked flask equipped with a magnetic stirrer and with a nitrogen outlet. The solution is heated at 70° C. for 12 hours under a stream of nitrogen. The solution is precipitated from one liter of ethyl ether and then the product is filtered off and dried under vacuum. The physicochemical characteristics of the oligomers with a trialkoxysilane ending are collated in table 5. Tg is the glass transition temperature of the matrix.

Stage 4: Thermal Crosslinking

The oligoimide with a trialkoxysilane ending grafted with DR1 is dissolved in a deposition solvent, such as 1,1,2-trichloroethane. The deposited layers are prepared from solutions composed of 20 parts by weight in 100 parts by weight of solvent (200 mg of product in 1 ml of 1,1,2-trichloroethane). After complete dissolution of the monomer and filtration (0.2 μm filter), the solution is deposited on a glass substrate by deposition using a whirler (v=1500 rev.min⁻¹, t=15 s, a=2000 rev.min⁻¹.s⁻¹), which results in the evaporation of the solvent. The thickness of the film is of the order of a few microns. The film obtained is heated from between one hour to two hours under a humid atmosphere at temperatures of between 190 and 200° C. in order to render it insoluble. This insolubility can be observed by immersing the film in the deposition solvent.

Stage 5: Orientation and Measurement of the Stability of the Electrooptic Properties

Studies have been carried out regarding the nonlinear optical properties and the stability of two oligoimides: AOI-6FAP3-DR1-TMS and AOI-6FAP3-DR1-TES, the chemical structures of which are represented by FIGS. 8a and 8b and the physicochemical characteristics of which are collated in table 6.

For each sample, the polymer film, oriented beforehand under a 5 kV electric field for 2 hours at 150° C., is heated with a temperature gradient of 3° C./min. The relaxation curves of the I_{2ω} signal (second harmonic intensity generated by the film when it is irradiated with a pulsed laser with a wavelength of 1.34 μm and detected with a photomultiplier at 670 nm) of the oligoimides AOI-6FAP3-DR1-TMS and AOI-6FAP3-DR1-TES are given in FIG. 5.

FIG. 9 is the superimposition of the relaxation curves of the I_{2ω} signals of AOI-6FAP3-DR1-TES and AOI-6FAP3-DR1-TMS crosslinked at 150° C. for 2 h. The relaxation temperatures measured (I_{2ω}/2) are 147° C. for crosslinked AOI-6FAP3-DR1-TMS and 155° C. for crosslinked AOI-6FPA3-DR1-TES.

Characterization of the Resistivity of the Material Obtained

The resistivity of the materials studied decreases with the temperature. The resistivities of the reference materials are measured at a lower temperature (120° C.) and have lower resistivities. The resistivity is calculated from the isochronous value (measured 10 minutes after the application of the voltage to the terminals of the sample) of the current passing into a cell with a thickness of approximately 1 micrometer of polymer contained between two gold electrodes and thermostatically controlled at 120° C. or 150° C. NOA65 and NOA61 are commercially available crosslinkable optical adhesives (Norland Optical Adhesives). AVO01 is a methacrylic-based fluorinated crosslinkable copolymer (Liang J., Toussaere E., Hierle R., Levenson R., Zyss J., Ochs A. V., Rousseau A., Boutevin B., “Low loss, low refractive index fluorinated self-crosslinking polymers waveguides for optical applications”, Optical Materials, 9, 1998, 230-235). OIP11 and OIP14 are crosslinked passive oligoimides described in this paper. PIA4-95 is a model polyimide substituted with DR1 (level of grafting 95%).

The results obtained are reproduced in FIG. 10, in which the resistivity measurements are collated for each material along a curve:

OIP11 (150° C.): curve (1)

PIA4-95 (150° C.: curve (a)

OIP14b (150° C.): curve (2)

NOA65 (120° C.): curve (b)

AV001 (120° C.): curve (c)

NOA61 (120° C.): curve (d).

OIP11 and OIP14 are crosslinkable passive oligoimides (without a crosslinking site for grafting a dye). They are obtained by copolymerization of 6FDA and of the fluorinated diamine 2,2′-bis(trifluoromethyl)-4,4′-diaminobiphenyl (BTDB). The crosslinking groups are of nadic type.

The main difference between these two oligoimides is their molecular mass: M=6220 for OIP11 and M=5900 for OIP14.

TABLE 1
Amounts of product in g (mmol) necessary for the
synthesis of oligohydroxyimides terminated by nadic or
allylic double bonds:

| | | | | Nadic | |
|---|---|---|---|---|---|
| Oligo- | | Hydroxydiamine | | anhydride | Allylamine |
| hydroxyimides | 6FDA | Type | Amount | (NA) | (AA) |
| AOI-HODA 1 | 3.62 | HODA | 2.00 | 0.35 | — |
| | (8.16) | | (9.24) | (2.16 | |
| AOI-HODA 2 | 1.18 | HODA | 0.51 | — | 0.03 |
| | (2.67) | | (2.37) | | (0.58) |
| AOI-6FAP 1 | 5.00 | 6FAP | 7.45 | 2.99 | — |
| | (11.25) | | (20.37) | (18.24) | |
| AOI-6FAP 2 | 5.00 | 6FAP | 5.19 | 0.97 | — |
| | (11.25) | | (14.20) | (5.90) | |
| AOI-6FAP 3 | 5.00 | 6FAP | 4.76 | 0.58 | — |
| | (11.25) | | (13.01) | (3.52) | |
| AOI-DHB 1 | 2.00 | DHB | 1.49 | 0.78 | — |
| | (4.50) | | (6.89) | (4.78) | |
| AOI-DHB 2 | 3.00 | DHB | 1.75 | 0.44 | — |
| | (6.75) | | (8.08) | (2.66) | |

TABLE 2
Physicochemical characterizations of the oligohydroxyimides:

| | | Chemical shifts in | |
|---|---|---|---|
| Oligo- | Yield | ¹H NMR δ (ppm) | FTIR characterizations |
| hydroxyimides | (%) | (CD₃COCD₃) | (KBr) |
| AOI-HODA 1 | 80 | 8.9 (s, OH), 8.2-7.1 | O—H: 3400 cm⁻¹ |
| | | (m, 159.5 aromatic | Arom. H—C: 3010 |
| | | H), 6.2 (s, 4Ha), | cm⁻¹ and 2940 |
| | | 3.4 (s, 2Hb), 3.3 | cm⁻¹ |
| | | (s, 2Hc), 1.7 (s, | |
| | | 2Hd, d′) | |
| AOI-HODA 2 | 84 | 10.0 (s, OH), 8.3-7.0 | —C═O: 1720 cm⁻¹ |
| | | (m, 78 aromatic | and 1780 cm⁻¹ |
| | | H), 5.9 (m, 2Hb), | —C═C—: 1625 cm⁻¹ |
| | | 5.1 (m, 4Ha), 4.2 | |
| | | (s, 4Hc) | |
| AOI-6FAP 1 | 86 | 9.5-9.0 (OH), 8.3-7.0 | —CF₃: 1300 cm⁻¹ |
| | | (m, 29.9 | and 715 cm⁻¹ |
| | | aromatic H), 6.2 (s, | |
| | | 4Ha), 3.4 (s, 2Hb), | |
| | | 3.3 (s, 2Hc), 1.7 | |
| | | (s, 2Hd, d′) | |
| AOI-6FAP 2 | 83 | 9.8 (s, OH), 8.3-7.0 | |
| | | (m, 59.8 aromatic | |
| | | H), 6.3 (s, 4Ha), | |
| | | 3.4 (s, 2Hb), 3.3 | |
| | | (s, 2Hc), 1.7 (s, | |
| | | 2Hd, d′) | |
| AOI-6FAP 3 | 85 | 8.3-7.4 (m, 95.6 | |
| | | aromatic H), 6.3 (s, | |
| | | 4Ha), 3.4 (s, 2Hb), | |
| | | 3.3 (s, 2Hc), 1.7 | |
| | | (s, 2Hd, d′) | |
| AOI-DHB 1 | | 9.0 (s, OH), 8.3-7.0 | |
| | | (m, 30.9 aromatic | |
| | | H), 6.3 (s, 4Ha), | |
| | | 3.4 (s, 2Hb), 3.3 | |
| | | (2, 2Hc), 1.7 (s, | |
| | | 2Hd, d′) | |
| AOI-DHB 2 | 85 | 9.0 (s, OH), 8.3-7.0 | |
| | | (m, 80.0 aromatic | |
| | | H), 6.3 (s, 4Ha), | |
| | | 3.4 (s, 2Hb), 3.3 | |
| | | (s, 2Hc), 1.7 (s, | |
| | | 2Hd, d′) | |

TABLE 3
Amounts of products in g (mmol) used for the
addition of DR1 to the oligohydroxyimides
AOI via the Mitsunobu reaction:

| Oligoimide | | | | |
|---|---|---|---|---|
| grafted with | Oligohydroxyimide | | | |
| DR1 | AOI | DR1 | PPh₃ | DEAD |
| AOI-HODA1-DR1 | 2.00 (3.25) | 1.54 | 1.29 | 0.85 |
| | | (4.91) | (4.91) | (4.91) |
| AOI-HODA2-DE1 | 1.30 (1.78) | 0.84 | 0.70 | 0.47 |
| | | (2.68) | (2.68) | (2.68) |
| AOI-6FAP1a- | 4.00 (10.87) | 5.12 | 4.29 | 2.84 |
| DR1 | | (16.31) | (16.31) | (16.31) |
| AOI-6FAP1b- | 4.00 (10.87) | 2.56 | 2.14 | 1.42 |
| DR1 | | (8.15) | (8.15) | (8.15) |
| AOI-6FAP2-DR1 | 4.00 (10.6) | 5.00 | 4.2 | 2.08 |
| | | (15.90) | (15.90) | (15.90) |
| AOI-6FAP3-DR1 | 2.00 (5.31) | 2.50 | 2.1 | 1.4 |
| | | (7.97) | (7.97) | (7.97) |
| AOI-DHB1-DR1 | 2.50 (8.56) | 4.03 | 3.37 | 2.23 |
| | | (12.83) | (12.83) | (12.83) |
| AOI-DHB2-DR1 | 2.50 (8.18) | 3.8 | 3.2 | 2.1 |
| | | (12.30) | (12.30) | (12.30) |

TABLE 4
UV/visible characterizations of the oligoimides grafted
with DR1, measured in DMF at Iₘₐₓ = 490 nm with an
extinction coefficient of 32 102 l · mol⁻¹ · cm⁻¹:

| Oligoimide | | Concentration by |
|---|---|---|
| grafted with DR1 | Absorbance at λₘₐₓ | mass in mg/l |
| AOI-HODA1-DR1 | 2.323 | 126.0 |
| AOI-HODA2-DR1 | 3.068 | 262.4 |
| AOI-6FAP1a-DR1 | 2.189 | 59.4 |
| AOI-6FAP1b-DR1 | 3.436 | 155.2 |
| AOI-6FAP2-DR1 | 2.515 | 67.3 |
| AOI-6FAP3-DR1 | 3.215 | 80.0 |
| AOI-DHB1-DR1 | 3.215 | 82.8 |
| APO-DHB2-DR1 | 2.960 | 78.5 |

TABLE 5
Characteristics of the α,ω-trialkoxysilane oligohydroxyimides
grafted with DR1:

| α,ω-Diene | | | | | |
|---|---|---|---|---|---|
| oligoimide (Mn | | | | | |
| in g · mol⁻¹ and | | | | | |
| Tg in ° C. of the | | α,ω-Trialkoxy- | | | |
| starting | Tg^{a)} | silaneoligo- | End- | Tg^{c)} | Solu- |
| oligomer, % DR1) | (° C.) | hydroxyimide | ing^{b)} | (° C.) | bility |
| AOI-6FAP1a-DR1 | 113 | AOI-6FAP1a-DR1- | TES | 177 | TCE^{d)} |
| (2200, 242, 76) | | TES | | | |
| | | AOI-6FAP1a-DR1- | TMS | 147 | |
| | | TMS | | | |
| | | AOI-6FAP1a-DR1- | DMA | 168 | |
| | | DMS | | | |
| AOI-6FAP1b-DR1 | 176 | AOI-6FAP1b-DR1- | TMS | 176 | |
| (2200, 242, 45) | | TMS | | | |
| AOI-6FAP2-DR1 | 197 | AOI-6FAP2-DR1- | TES | 173 | |
| (4070, 246, 78) | | TES | | | |
| | | AOI-6FAP2-DR1- | TMS | 185 | |
| | | TMS | | | |
| | | AOI-6FAP2-DR1- | DMS | 186 | |
| | | DMA | | | |
| AOI-6FAP3-DR1 | 186 | AOI-6FAP3-DR1- | TES | 176 | |
| (6440, 285, 85) | | TES | | | |
| | | AOI-6FAP3-DR1- | TMS | 180 | |
| | | TMS | | | |
| AOI-DHB1-DR1 | 188 | AOI-DHB1-DR1- | TES | 141 | 1/3 γ- |
| (1800, nd, 70) | | TES | | | butyro- |
| | | | | | lactone |
| AOI-DHB2-DR1 | 184 | AOI-DHB2-DR1- | TES | 176 | 2/3 |
| (4400, nd, 73) | | TES | | | TCE |

^{a)}Tg of the starting α,ω-diene oligoimides,
^{b)}TES: triethoxysilane, TMS: trimethoxysilane, and DMS: dimethoxysilane,
^{c)}Tg of the α,ω-trialkoxysilane oligoimides, measured during the second rise in temperature from 50 to 240° C. at 20° C..min⁻¹,
^{d)}1,1,2-trichloroethane.

TABLE 6
Characteristics of the crosslinkable oligoimides:

| | | Level of grafting | |
|---|---|---|---|
| | | of the DR1 | Deposition |
| Oligoimide | Tg (° C.) | (mol %) | condition |
| AOI-6FAP3- | 180 | 85 | 10% by weight |
| DR1-TMS | | | in 1,2,2- |
| | | | trichloroethane |
| AOI-6FAP3- | 176 | 85 | 10% by weight |
| DR1-TES | | | in 1,2,2- |
| | | | trichloroethane |

1. A process for the preparation of an electrooptic material, characterized in that a solution of oligoimides, to which orientable dyes are grafted, is deposited on a substrate and in that use is made of a treatment capable of crosslinking the oligoimide and of orienting the dyes.

2. The process for the preparation of an electrooptic material as claimed in claim 1, characterized in that the dyes are oriented under an electric field.

3. The process for the preparation of an electrooptic material as claimed in claim 1, characterized in that the dyes are oriented under an optical field.

4. The process for the preparation of an electrooptic material as claimed in one of the preceding claims, characterized in that the oligoimide solution is obtained by the stages consisting of:
the synthesis of oligoimides terminated by reactive double bonds,
the addition of orientable dyes to the OH functional side groups of the oligoimides,
the grafting of crosslinking groups to the double bonds at the chain end.

5. The process for the preparation of electrooptic material as claimed in claim 1, characterized in that the crosslinking of the oligoimides is obtained by addition of a crosslinking agent.

6. The process for the preparation of electrooptic material as claimed in claim 5, characterized in that the crosslinking agent used is chosen from the following compounds: 1,1,1-tris(4-hydroxyphenyl)ethane or oxalic acid or pentaerythritol tetrakis(3-mercaptopropionate) or tetramethylcyclotetrasiloxane.

7. The process for the preparation of electrooptic material as claimed in claim 5, characterized in that the crosslinking groups are of alkoxysilane or nadic or allylic type.

8. The process for the preparation of electrooptic material as claimed in claim 1, characterized in that the crosslinking is obtained without the addition of crosslinking agent via a reaction between the crosslinking groups situated at the chain end of the oligoimides.

9. The process for the preparation of electrooptic materials as claimed in claim 8, characterized in that the crosslinking groups are of alkoxysilane or nadic or allylic or maleimide or acetylene or benzocyclobutene or cyanate type.

10. A polyimide solution, characterized in that, for the implementation of the process as claimed in claim 1, it comprises crosslinkable oligoimides to which orientable dyes are grafted.

11. The solution as claimed in claim 10 for the implementation of the process, characterized in that the dye used is a hyperpolarizable compound.

12. The solution as claimed in claim 10 for the implementation of the process, characterized in that the oligoimides are fluorinated.

13. The solution as claimed in claims 10 and 12 for the implementation of the process, characterized in that said oligoimides are oligohydroxyimides.

14. The solution as claimed in claim 13 for the implementation of the process, characterized in that the oligohydroxyimides are obtained from 4,4′-(hexafluoroisopropylidene). [lacuna] (6FDA) and from one of the following compounds: 4-(4-amino-2-hydroxy)phenoxyaniline (HODA) or 2,2-bis-(3-amino-4-hydroxyphenyl)hexafluoropropane (6FAP) or 3,3′-dihydroxy-4,4′-diaminobiphenyl (DHB).

15. The solution as claimed in claim 10 for the implementation of the process, characterized in that the crosslinking groups are of alkoxysilane or nadic or allylic or maleimide or acetylene or benzocyclobutene or cyanate type.

16. The solution as claimed in claim 15 for the implementation of the process, characterized in that the crosslinking groups are α,ω-trialkoxysilanes or triethoxysilanes (TES) or trimethoxysilanes (TMS).
